(19) United States
(12) Patent Application Publication
(10) Pub. No.: US 2007/0279197 A1
(43) Pub. Date: Dec. 6, 2007

(54) Electric Home Appliance Able To Power Line Communication

(76) Inventors: Yang Hwan No, Gyeongsangnam-do (KR); Yong Hoan Kwon, Busan (KR); Hoon Bong Lee, Gyeongsangnam-do (KR); Ho Sung Jang, Gyeongsangnam-do (KR); Kyoo Cheol Choi, Gyeongsangnam-do (KR); Han Ki Cho, Gyeongsangnam-do (KR); Yong Tae Kim, Gyeongsangnam-do (KR)

Correspondence Address: KED & ASSOCIATES, LLP, P.O. Box 221200, Chantilly, VA, 20153-1200, US

(21) Appl. No.: 10/593,618

(22) PCT Filed: Dec. 21, 2005
(86) PCT No.: PCT/KR05/04435

§ 371 Date: Jul. 18, 2007

(30) Foreign Application Priority Data
Dec. 30, 2004 (KR) 10-2004-0116090
Dec. 30, 2004 (KR) 10-2004-0116089
Dec. 30, 2004 (KR) 10-2004-0116088

(51) Int. Cl. G05B 11/01

(52) U.S. Cl. 340/310.16

(57) ABSTRACT

An object of the present invention is to provide a home appliance which enables power line communication therewith for remote monitoring of progress of the home appliance, such as a washing machine or dryer. For this, the present invention provides a home appliance which enables power cable communication therewith, including a body (10) forming an exterior of the home appliance, a main control unit (20) at the body (10), for making various kinds of control of the home appliance, and a power cable communication modem (230) at the body (10), for transmission/reception of various kinds of data to/from a remote monitor which monitors the home appliance, remotely.

### TECHNICAL FIELD

The present invention relates to home appliances, and more particularly, to a home appliance, such as a washing machine or a dryer, which enables a user to make power line communication therewith for monitoring progress thereof, remotely.

### BACKGROUND ART

In general, the home appliance, an apparatus for operating by using electricity in a home, converts the electricity into a light, heat, or power, for convenience of a home life.

Recently, different from other home appliances, since a washing machine, or a dryer using electricity as power, not only occupies a large installation space, but also has big noise and vibration generated when the washing machine or dryer is in operation, the washing machine, or a dryer is in general installed at a place, such as veranda, far from a living room.

Particularly, due to structures of most houses in the USA, and Europe, the washing machine is installed in a cellar, or separate warehouse, or the like, far from a living space in practice.

Thus, the installation of the washing machine far from a living roan where a user stays most of time causes difficulty in knowing progress of the washing machine, such as the present cycle of the washing machine or a time period left, easily.

That is, it is required for the user to go to the place where the washing machine is from time to time, for determining a state of progress of the washing machine every time, personally.

Moreover, after putting the washing machine into operation, if the user forgets a fact that the user put the washing machine into operation for a moment or completely, the laundry finished washing rumples, or has microbes increased thereon, to damage the laundry.

Furthermore, the user is liable to fail to notice an error in the cycle of the washing machine, to fail in taking a proper countermeasure, leaving the laundry in contact with detergent and the washing water for a long time to cause decoloring of the laundry, thereby damaging cloth of the laundry itself.

Therefore, a remote monitoring system is in need for monitoring the home appliance from a user's desired place.

### DISCLOSURE OF INVENTION

### Technical Problem

The object of the present invention, designed for solving the problems of the related art, lies on providing a home appliance which enables a user to make power line communication therewith, for easy, and remote monitoring, and control of a state of the home appliance, such as a washing machine, or dryer far from a user, for convenient and effective use of the home appliance.

### Technical Solution

The object of the present invention can be achieved by providing a home appliance which enables power cable communication therewith, including a body forming an exterior of the home appliance, a main control unit at the body, for making various kinds of control of the home appliance, and a power cable communication modem at the body, for transmission/reception of various kinds of data to/from a remote monitor which monitors the home appliance remotely.

In another aspect of the present invention, a home appliance which enables power cable communication therewith, includes a body forming an exterior of the hone appliance, a main control unit at the body, for making various kinds of control of the home appliance, a power cable communication modem at the body, for transmission/reception of various kinds of data to/from a remote monitor which monitors the home appliance remotely, a line connector connected both to the signal lines of the main control unit and the power line of the home appliance, and a line connection connector at the power cable communication modem for making the power cable communication modem to be connected to the signal lines of the main control unit and the power line of the home appliance at a time as the line connection connector is detachably connected to the line connector.

In another aspect of the present invention, a home appliance which enables power cable communication therewith, includes a body forming an exterior of the hone appliance, a main control unit at the body, for making various kinds of control of the home appliance, a power cable communication modem at the body, for transmission/reception of various kinds of data to/from a remote monitor which monitors the home appliance remotely, a line connector connected both to the signal lines of the main control unit and the power line of the home appliance, a line connection connector at the power cable communication modem for making the power cable communication modem to be connected to the signal lines of the main control unit and the power line of the home appliance at a time as the line connection connector is detachably connected to the line connector, and a connector cover for detachable connection to the line connector when the power cable communication modem is not mounted to the line connector for preventing foreign matters from infiltrating into the line connector.

In another aspect of the present invention, a home appliance which enables power cable communication therewith, includes a body forming an exterior of the home appliance, a main control unit at the body, for making various kinds of control of the home appliance, a power cable communication modem at the body, for transmission/reception of various kinds of data to/from a remote monitor which monitors the home appliance remotely, a signal connector connected to the signal lines at the main control unit, a power connector connected to the power line to the home appliance, a signal connection connector at the power cable communication modem for connection to the signal connector, a power source connection connector at the power cable communication modem for connection to the power connector, and a connector cover for detachable connection to the line connector when the power cable communication modem is not mounted to the line connector for preventing foreign matters from infiltrating into the line connector.

### ADVANTAGEOUS EFFECTS

The home appliance which enables power cable communication therewith of the present invention has the following effects.

First, the user's easy and remote detection and control of a state of a home appliance is permitted.

Second, the user can take an appropriate measure at an appropriate time for the home appliance enabling an effective management of the home appliance, such as maintenance of the home appliance.

Third, user's effective management of things, such as laundry, cooking objects, and the like, used for the home appliance is permitted.

Fourth, easy mounting of the power cable communication modem to the home appliance is permitted.

Fifth, easy connection of the power cable, and signal lines to the power cable communication modem is permitted.

### BRIEF DESCRIPTION OF THE DRAWINGS

The accompanying drawings, which are included to provide a further understanding of the invention, illustrate embodiment(s) of the invention and together with the description serve to explain the principle of the invention. In the drawings;

FIG. 1 illustrates a diagram showing a state of use of a home appliance which enables power line communication therewith in accordance with a preferred embodiment of the present invention, schematically;

FIG. 2 illustrates a perspective view of a home appliance which enables power line communication therewith in accordance with a first preferred embodiment of the present invention;

FIG. 3 illustrates a perspective view of a home appliance which enables power line communication therewith in accordance with a second preferred embodiment of the present invention;

FIG. 4 illustrates a perspective view of a home appliance which enables power line communication therewith in accordance with a third preferred embodiment of the present invention;

FIG. 5 illustrates a perspective view of a secured state of the line connector in FIG. 4 seen from an inside of a body;

FIG. 6 illustrates a perspective view of a connector cover on the line connector in FIG. 4;

FIG. 7 illustrates a perspective view of the cover in FIG. 6;

FIG. 8 illustrates a cross section of the connector cover in FIG. 6 connected to a line connector;

FIG. 9 illustrates a cross section of the connector cover in FIG. 6 showing a state hooks on elastic pieces thereof are disengaged from a line connector;

FIG. 10 illustrates a perspective view of a home appliance which enables power line communication therewith in accordance with a fourth preferred embodiment of the present invention; and

FIG. 11 illustrates a perspective view showing secured states of a signal connector and a power connector in FIG. 6, seen from an inside of a body.

### BEST MODE FOR CARRYING OUT THE INVENTION

Preferred embodiments of the present invention will be described with reference to the attached drawings.

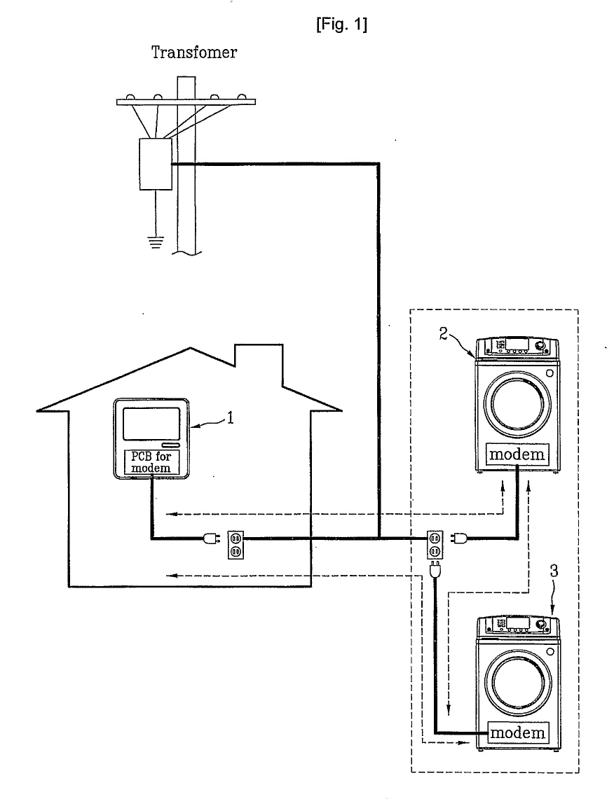

Referring to FIG. 1, a power cable communication modem is mounted on each of home appliances, such as a washing machine 2 and a dryer 3 (hereafter called as home appliances, collectively) in a space (a veranda, or cellar) far from a living room or a bed room for making remote monitoring.

A remote monitor 1, provided to a place where a user stays most of the time (i.e., a place the user desires to make the remote monitoring), is connected to each of the power cable communication modems on the home appliances with power cables for transmitting progress of the home appliances to the user.

That is, the remote monitor 1 has a display circuit board (not shown), and a communication modem (not shown) mounted therein, for transmission/reception of data to/from the power cable modems on the home appliances, so that the user can monitor progress of the home appliances.

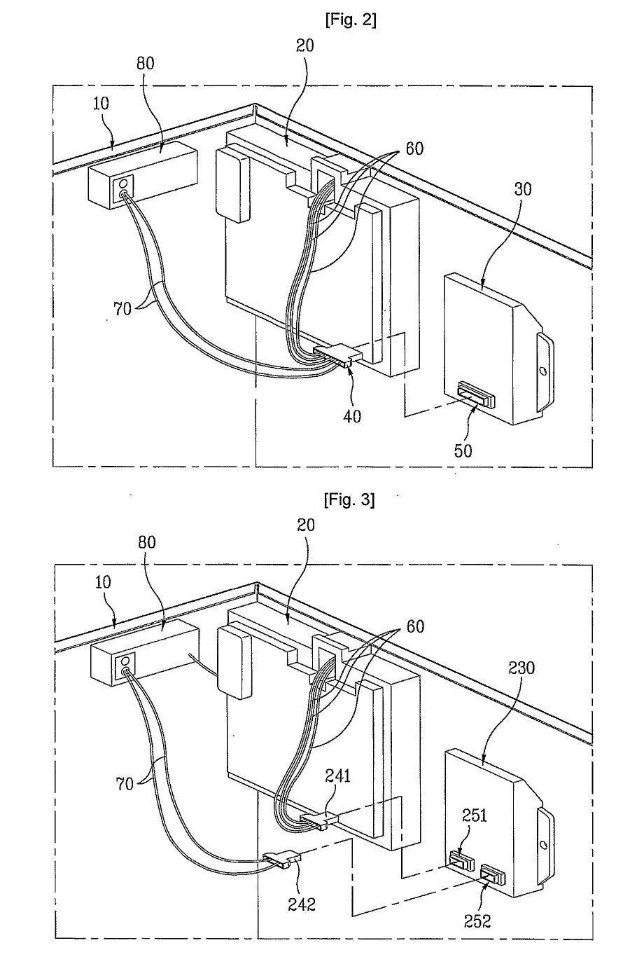

A home appliance which enables power line communication therewith in accordance with a first preferred embodiment of the present invention will be described with reference to FIG. 2.

Referring to FIG. 2, the home appliance includes a body 10, a main control unit 20, and a power cable communication modem 30.

The body 10 forms an exterior of the home appliance.

The main control unit 20 is in the body 10 for making various kinds of control of the home appliance.

The power cable communication modem 30 is of a built-in type in the body 10, connected to signal lines 60 at the main control unit 20 and a power line for the home appliance for transmission/reception of various data to/from the remote monitor 1 (see FIG. 1) that makes remote monitoring of a state of the home appliance.

In the meantime, the power cable communication modem 30 may be fastened to an inside of the body 10 with fastening members (not shown), or to a separate fixing bracket fixedly secured to the inside of the body 10.

The signal lines 60 at the main control unit 20 and the power cables 70 for the home appliance are connected to one line connector 40, and the power cable communication modem 30 has a line connection connector 50 for detachable connection of the line connector 40.

Accordingly, when the line connector 40 is connected to the line connection connector 50, the power cable communication modem 30 is connected both to the main control unit 20 and a power source, at a time.

In this instance, it is preferable that the line connector 40 and the line connection connector 50 are detachably connected to each other in shapes of a female terminal and a male terminal of a hook type.

That is, the line connector 40 and the line connection connector 50 are electrically connected as the female terminal and the male terminal are brought into contact with each other at the moment the line connector 40 and the line connection connector 50 are connected.

In the meantime, for preventing noise of an external power source from transmitting to the main control unit 20 and the power cable communication modem 30, the home appliance further includes a noise filter 80.

The noise filter 80 has an input terminal connected to an external power line to the home appliance, and an output terminal in the body 10 for connection to the main control unit 20 and the line connector 40.

That is, the power to the home appliance has the noise removed therefrom as the power passes through the noise filter 80 before being supplied to the main control unit 20 and the power cable communication modem 30.

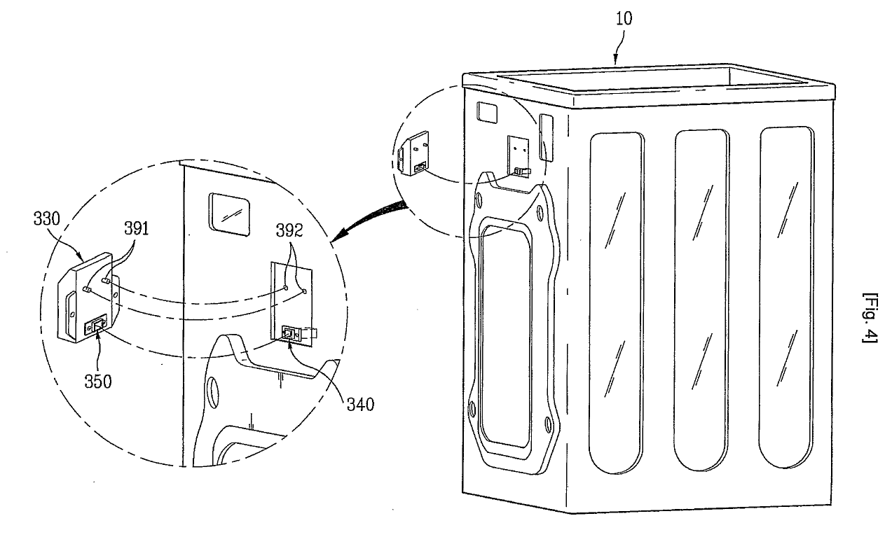

Next, a home appliance which enables power line communication therewith in accordance with a second preferred embodiment of the present invention will be described with reference to FIG. 3.

Referring to FIG. 3, alike the first embodiment, the home appliance includes a body 10, a main control unit 20, and a power cable communication modem 230.

The power cable communication modem 230 also is of a built-in type fastened to an inside of the body only with fastening members (not shown) or with a separate fixing bracket (not shown).

However, the power cable communication modem 230 in the home appliance which enables power line communication therewith in accordance with a second preferred embodiment of the present invention is connected to the main control unit 20 and a power source through a signal connector 241, and a power connector 241, and a signal connection connector 251 and a power connection connector 252 corresponding thereto, respectively.

In more detail, the signal connector 241 is connected to the signal lines 60 at the main control unit 20, the power connector 242 is connected to the power source line 70 through which a power is supplied, and the power cable communication modem 230 is provided with a signal connection connector 251 and a power connection connector 252 in correspondence to the signal connector 241 and the power connector 242, respectively.

As the signal connector 241 is connected to the signal connection connector 251, and the power connector 242 is connected to the power source connection connector 252, the power cable communication modem 230 is connected both to the main control unit 20 and the power source, to transmit/receive various data to/from a remote monitor 1 (see FIG. 1) that makes remote monitoring of a state of the home appliance.

In this instance, it is preferable that the signal connector 241 and the signal connection connector 251, and the power connector 242 and the power source connection connector 252 are detachably connected to each other in a hook type with shapes of a female terminal and a male terminal, respectively.

That is, the signal connector 241 and the signal connection connector 251, and the power connector 242 and the power source connection connector 252 are electrically connected respectively as the female terminal and the male terminal are engaged with each other, to bring the female terminal and the male terminal in contact with each other.

In the meantime, the home appliance in accordance with a second embodiment of the present invention also further includes a noise filter 80 for preventing noise of external power source from transmitting to the main control unit 20 and the power cable communication modem 230.

The noise filter 80 has an input terminal connected to an external power cable to the home appliance, and an output terminal in the body 10 for connection to the main control unit 20 and the power connector 242.

That is, the power to the home appliance has the noise removed therefrom as the power passes through the noise filter 80 before being supplied to the main control unit 20 and the power cable communication modem 230.

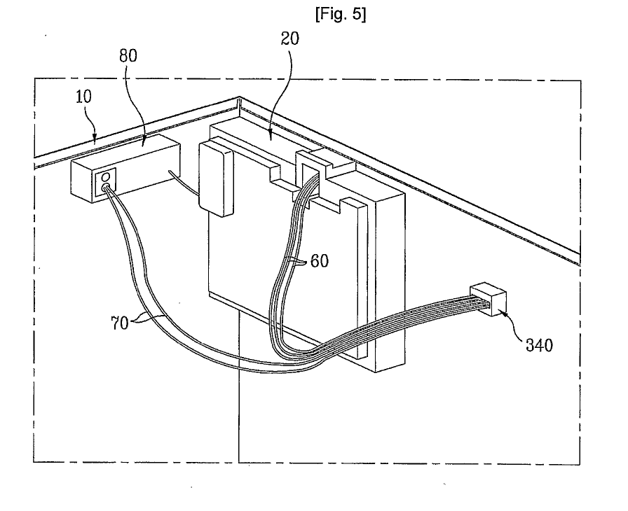

Next, a home appliance which enables power line communication therewith in accordance with a third preferred embodiment of the present invention will be described, with reference to FIGS. 4 and 5.

Referring to FIGS. 4 and 5, alike the first embodiment, the home appliance which enables power line communication therewith in accordance with a third preferred embodiment of the present invention includes a body 10, a main control unit 20, and a power cable communication modem 330.

The body 10 forms an exterior of the home appliance, and the main control unit 20 is in the body 10 for making various kinds of control of the home appliance.

However, the power cable communication modem 330 is of an exterior mounting type to be exposed to an outside of the body 10, and connected to signal lines 60 at the main control unit 20 and a power line 70 for the home appliance, for transmission/reception of various data to/from the remote monitor 1 (see FIG. 1) that makes remote monitoring of a state of the home appliance.

In the meantime, the power cable communication modem 330 may be fastened to an outside of the body 10 with fastening members (not shown), or to a separate fixing bracket (not shown) fixedly secured to the outside of the body 10.

It is preferable that there are a positioning boss 391 formed on an outside surface of the power cable communication modem 330, or the body 10, and a positioning hole 392 on an opposite side of the positioning boss 391 for joining with the positioning boss 391.

That is, mounting work of the power cable communication modem 330 can be improved by making the mounting work to pass through a preliminary mounting stage in which the positioning boss 391 is placed in the positioning hole 392 before the power cable communication modem 330 is mounted to the outside surface of the body 10 with the fastening members.

In the meantime, the signal lines 60 at the main control unit 20 and the power cables 70 for the home appliance are connected to one line connector 340 which is fixedly secured to the body 10 so as to be exposed to an outside of the body 10. The power cable communication modem 330 has a line connection connector 350 for detachable connection of the line connector 340.

Accordingly, when the line connection connector 350 of the power cable communication modem 330 is connected to the line connector 340 exposed to an outside surface of the body 10, the power cable communication modem 330 is connected both to the main control unit 20 and a power source, at a time.

In this instance, it is preferable that the line connector 340 and the line connection connector 350 are detachably connected to each other in shapes of a female terminal and a male terminal of a hook type.

That is, the line connector 340 and the line connection connector 350 are electrically connected as the female terminal and the male terminal are brought into contact with each other at the moment the line connector 340 and the line connection connector 350 are connected.

In the meantime, for preventing noise of an external power source from transmitting to the main control unit 20 and the power cable communication modem 330, the home appliance further includes a noise filter 80.

The noise filter 80 has an input terminal connected to an external power cable to the home appliance, and an output terminal in the body 10 for connection to the main control unit 20 and the line connector 340.

That is, the power to the home appliance has the noise removed therefrom as the power passes through the noise filter 80 before being supplied to the main control unit 20 and the power cable communication modem 330.

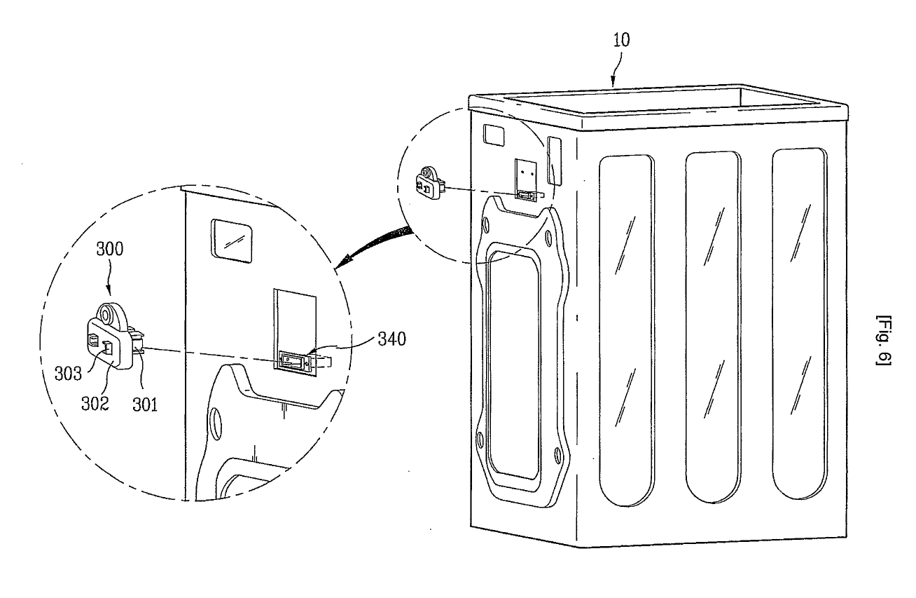

In the meantime, referring to FIG. 6, the home appliance in accordance with the third preferred embodiment of the present invention is vulnerable to infiltration of foreign matters, such as dust, into the line connector 340 if the power cable communication modem 330 is not mounted thereon.

Accordingly, for preventing this from taking place, the line connector 340 has a connector cover 300 detachably provided thereto when the power cable communication modem 330 in not mounted.

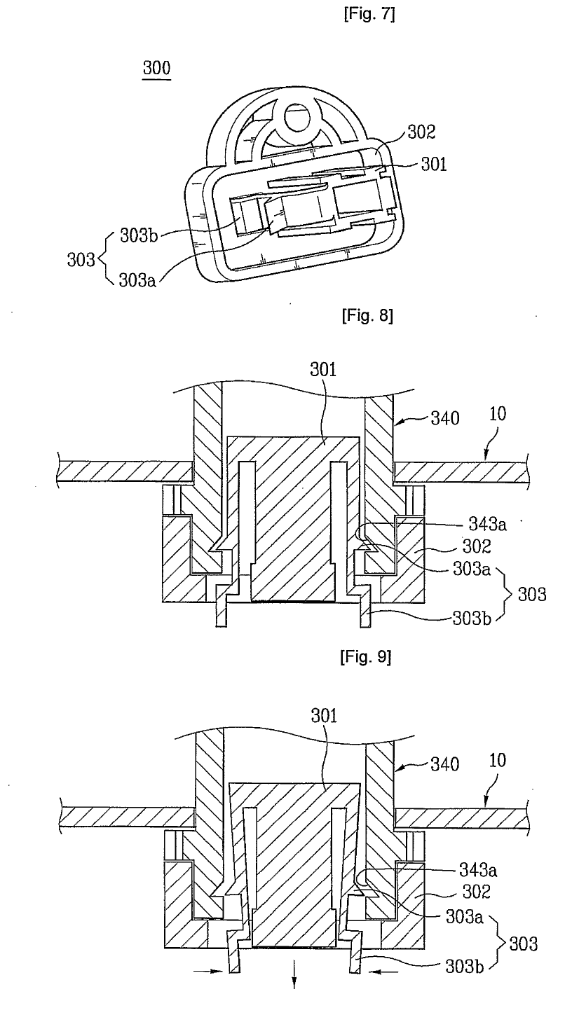

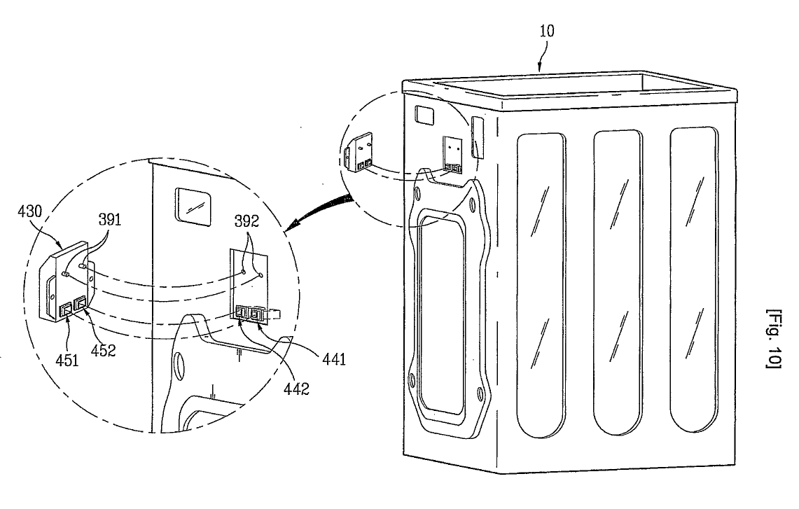

Referring to FIGS. 7 to 9, the connector cover 300 includes a plug portion 301 and a cover portion 302.

The plug portion 301 is placed in the line connector 340 when the connector cover 300 is mounted to the line connector 340, and the cover portion 302, at rear of the plug portion 301, encloses a circumference of the line connector 340 when the connector cover 300 is mounted to the line connector 340.

It is preferable that the line connector 340 has hook slots 343a in an inside thereof, and the connector cover 300 includes elastic pieces each having a hook 303a in correspondence to each of the hook slots 343a.

That is, the elastic piece 303 on the connector cover 300 includes the hook 303a in correspondence to the hook slot 343a, with an end 303b of the hook 303a extended through a pass through hole in the cover portion 302 so as to be exposed to an outside of the cover portion 302, for enabling handling.

In the meantime, it is effective that the connector cover 300 is formed of plastic or synthetic resin.

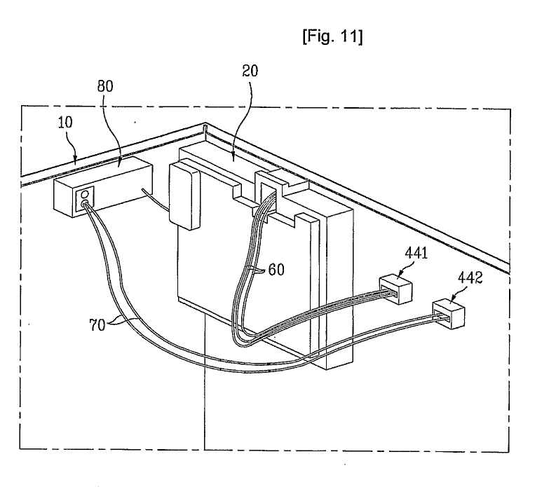

Next, a home appliance which enables power line communication therewith in accordance with a fourth preferred embodiment of the present invention will be described, with reference to FIGS. 10 and 11.

Referring to FIGS. 10 and 11, alike the third embodiment, the home appliance which enables power line communication therewith in accordance with a fourth preferred embodiment of the present invention includes a body 10, a main control unit 20, and a power cable communication modem 430.

The power cable communication modem 430 is also of an exterior mounting type to be fastened to an outside of the body 10 only with fastening members (not shown), or to a separate fixing bracket (not shown).

It is preferable that there are a positioning boss 391 formed on an outside surface of the power cable communication modem 430, or the body 10, and a positioning hole 392 on an opposite side of the positioning boss 391 for joining Pith the positioning boss 391.

That is, mounting work of the power cable communication modem 430 can be improved by making the mounting work to pass through a preliminary mounting stage in which the positioning boss 391 is placed in the positioning hole 392 before the power cable communication modem 430 is mounted to the outside surface of the body 10 with the fastening members.

The body 10 forms an exterior of the home appliance, and the main control unit 20 is in the body 10 for making various kinds of control of the home appliance.

However, the power cable communication modem 430 is connected to the main control unit 20 and a power source through a signal connector 441, and a power connector 442, and a signal connection connector 451 and a power connection connector 452 to be connected to the signal connector 441 and the power connector 442, respectively.

In more detail, the signal connector 441 is connected to signal lines 60 at the main control unit 20, and the signal connector 441 and the power connector 442 are secured to the body 10 so as to be exposed to an outside of the body 10.

The power cable communication modem 430 is provided Math a signal connection connector 451 and a power source connection connector 452 in correspondence to the signal connector 441 and the power connector 442, respectively.

Therefore, following connection of the signal connector 441 to the signal connection connector 451, and connection of the power connector 442 to the power source connection connector 452, the power cable communication modem 430 is connected to the main control unit 20 and the power source at a time, for transmission/reception of various data to/from the remote monitor 1 (see FIG. 1) that makes remote monitoring of a state of the home appliance by a power cable communication system.

In this instance, it is preferable that the signal connector 441 and the signal connection connector 451, and the power connector 442 and the power source connection connector 452 are detachably connected to each other in shapes of female terminals and male terminals of a hook type.

That is, the signal connector 441 and the signal connection connector 451, and the power connector 442 and the power source connection connector 452 are electrically connected as the female terminals and the male terminals are brought into contact with each other at the moment the signal connector 441 and the signal connection connector 451, and the power connector 442 and the power source connection connector 452 are connected, respectively.

In the meantime, for preventing noise of an external power source from transmitting to the main control unit 20 and the power cable communication modem 430, the home appliance in accordance with the fourth preferred embodiment of the present invention further includes a noise filter 80.

The noise filter 80 has an input terminal connected to an external power cable to the home appliance, and an output terminal in the body 10 for connection to the main control unit 20 and the power connector 442.

That is, the power to the home appliance has the noise removed therefrom as the power passes through the noise filter 80 before being supplied to the main control unit 20 and the power cable communication modem 430.

In the meantime, though not shown, the home appliance in accordance with the fourth preferred embodiment of the present invention is also vulnerable to infiltration of foreign matters, such as dust, into the signal connector 441 and the power connector 442 if the power cable communication modem 430 is not mounted thereon.

Accordingly, for preventing this from taking place, the signal connector 441 and the power connector 442 have connector covers respectively provided thereto when the power cable communication modem 430 in not mounted.

It is preferable that the connector covers respectively provided to the signal connector 441 and the power connector 442 have shapes identical to a shape of the connector cover 300 in FIGS. 6 to 9.

That is, it is preferable that the connector covers are formed of plastic or synthetic resin, with shapes identical to the connector cover 300, and with sizes corresponding to the signal connector 441 and the power connector 442, respectively.

Accordingly, the home appliance in accordance with the fourth preferred embodiment of the present invention can also prevent foreign matters, such as dust, from infiltrating into insides of the signal connector 441 and the power connector 442 in a case the power cable communication modem 430 is not mounted.

It will be apparent to those skilled in the art that various modifications and variations can be made in the present invention without departing from the spirit or scope of the inventions. Thus, it is intended that the present invention covers the modifications and variations of this invention provided they came within the scope of the appended claims and their equivalents.

### INDUSTRIAL APPLICABILITY

The remote monitor for home appliance of the present invention has significantly high industrial applicability because the remote monitor permits, firstly, the user's easy and remote detection and control of a state of a home appliance, secondly, the user to take an appropriate measure at an appropriate time for the home appliance enabling an effective management of the home appliance, such as maintenance of the hone appliance, thirdly, user's effective management of things, such as laundry, cooking objects, and the like, used for the home appliance, fourthly, easy mounting of the power cable communication modem to the home appliance, and fifthly, easy connection of the power cable, and signal lines to the power cable communication modem.

1. A home appliance which enables power cable communication therewith, comprising:
a body forming an exterior of the home appliance;
a main control unit at the body, for making various kinds of control of the home appliance; and
a power cable communication modem at the body, for transmission/reception of various kinds of data to/from a remote monitor which monitors the home appliance remotely.

2. The home appliance as claimed in claim 1, wherein the power cable communication modem is connected to signal lines of the main control unit and a power line of the home appliance for transmission/reception of data to/from the remote monitor.

3. The home appliance as claimed in claim 1, further comprising:
a line connector having the signal lines of the main control unit and the power line of the home appliance connected thereto together; and
a line connection connector at the power cable communication modem for making the power cable communication modem to be connected to the signal lines of the main control unit and the power line of the home appliance at a time as the line connection connector is detachably connected to the line connector.

4. The home appliance as claimed in claim 3, wherein the line connector and the line connection connector are detachably connected to each other in shapes of a female terminal and a male terminal of a hook type.

5. The home appliance as claimed in claim 3, further comprising a connector cover for detachable connection to the line connector when the power cable communication modem is not mounted to the line connector for preventing foreign matters from infiltrating into the line connector.

6. The home appliance as claimed in claim 5, wherein the connector cover includes;
a plug portion for being placed in the line connector, and
a cover portion at rear of the plug portion for enclosing a circumference of the line connector.

7. The home appliance as claimed in claim 6, wherein the plug portion includes;
a hook for detachable engagement with a hook slot inside of the line connector, and
an end the hook extended through a pass through hole in the cover portion so as to be exposed to an outside of the cover portion, for enabling handling.

8. The home appliance as claimed in claim 5, wherein the connector cover is formed of plastic or synthetic resin.

9. The home appliance as claimed in claim 1, further comprising:
a signal connector connected to the signal lines at the main control unit;
a power connector connected to the power line to the home appliance;
a signal connection connector at the power cable communication modem for connection to the signal connector; and
a power source connection connector at the power cable communication modem for connection to the power connector.

10. The home appliance as claimed in claim 9, wherein the signal connector and the signal connection connector, and the power connector and the power source connection connector are detachably connected to each other respectively in shapes of female terminals and male terminals of a hook type.

11. The home appliance as claimed in claim 1, wherein the power cable communication modem is a built-in type modem provided to an inside of the body.

12. The home appliance as claimed in claim 11, wherein the power cable communication modem is fixedly secured to an inside surface of the body with fastening members.

13. The home appliance as claimed in claim 11, wherein the power cable communication modem is fixedly secured to a fixing bracket on an inside surface of the body.

14. The home appliance as claimed in claim 1, wherein the power cable communication modem is of an exterior mounting type to be exposed to an outside of the body.

15. The home appliance as claimed in claim 14, wherein the power cable communication modem is fixedly secured to an outside surface of the body with fastening members.

16. The home appliance as claimed in claim 14, wherein one of the power cable communication modem and the body includes a positioning boss, and the other one of the power cable communication modem and the body includes a positioning hole opposite to the positioning boss for placing the positioning boss therein.

17. The home appliance as claimed in claim 1, further comprising a noise filter in the body for preventing noise of a power source from transmitting to the main control unit and the power cable communication modem.

18. The home appliance as claimed in claim 1, wherein the noise filter has an input terminal connected to an external power line to the home appliance, and an output terminal connected to the main control unit and the power cable communication modem.

19. A home appliance which enables power cable communication therewith, comprising:
a body forming an exterior of the home appliance;
a main control unit at the body, for making various kinds of control of the home appliance;
a power cable communication modem at the body, for transmission/reception of various kinds of data to/from a remote monitor which monitors the home appliance remotely;
a line connector connected both to the signal lines of the main control unit and the power line of the home appliance; and
a line connection connector at the power cable communication modem for making the power cable communication modem to be connected to the signal lines of the main control unit and the power line of the home appliance at a time as the line connection connector is detachably connected to the line connector.

20. A home appliance which enables power cable communication therewith, comprising:
a body forming an exterior of the home appliance;
a main control unit at the body, for making various kinds of control of the home appliance;
a power cable communication modem at the body, for transmission/reception of various kinds of data to/from a remote monitor which monitors the home appliance remotely;
a line connector connected both to the signal lines of the main control unit and the power line of the home appliance;
a line connection connector at the power cable communication modem for making the power cable communication modem to be connected to the signal lines of the main control unit and the power line of the home appliance at a time as the line connection connector is detachably connected to the line connector; and
a connector cover for detachable connection to the line connector when the power cable communication modem is not mounted to the line connector for preventing foreign matters from infiltrating into the line connector.

21. A home appliance which enables power cable communication therewith, comprising:
a body forming an exterior of the home appliance;
a main control unit at the body, for making various kinds of control of the home appliance;
a power cable communication modem at the body, for transmission/reception of various kinds of data to/from a remote monitor which monitors the home appliance remotely;
a signal connector connected to the signal lines at the main control unit;
a power connector connected to the power line to the home appliance;
a signal connection connector at the power cable communication modem for connection to the signal connector; and
a power source connection connector at the power cable communication modem for connection to the power connector.

22. A home appliance which enables power cable communication therewith, comprising:
a body forming an exterior of the home appliance;
a main control unit at the body, for making various kinds of control of the home appliance;
a power cable communication modem at the body, for transmission/reception of various kinds of data to/from a remote monitor which monitors the home appliance remotely;
a signal connector connected to the signal lines at the main control unit;
a power connector connected to the power line to the home appliance;
a signal connection connector at the power cable communication modem for connection to the signal connector;
a power source connection connector at the power cable communication modem for connection to the power connector; and
a connector cover for detachable connection to the line connector when the power cable communication modem is not mounted to the line connector for preventing foreign matters from infiltrating into the line connector.
